(19) United States
(12) Patent Application Publication
(10) Pub. No.: US 2009/0216438 A1
(43) Pub. Date: Aug. 27, 2009

(54) FACILITY MAP FRAMEWORK

(75) Inventor: Steven Arthur N. Shafer, Seattle, WA (US)

Correspondence Address: TUROCY & WATSON, LLP, 127 Public Square, 57th Floor, Key Tower, CLEVELAND, OH, 44114, US

(73) Assignee: Microsoft Corporation, Redmond, WA (US)

(21) Appl. No.: 12/035,017

(22) Filed: Feb. 21, 2008

(51) Int. Cl. G06F 19/00; G01S 5/00

(52) U.S. Cl. 701/210; 701/209; 701/213

(57) ABSTRACT

A facility map framework system facilitates creation of map and asset descriptions and integrates map information to form a facility map object model with defined connections and constraints between and within maps of disparate character (e.g., geographic road maps, facility floor plans, campus layouts, stacked vertical floor layouts, and cross sections in elevation (e.g., equipment positioning, storage location as viewed, etc.)). Routing through the object map is informed of a user's starting and/or current location, desired target, and mobility characteristics (e.g., disabilities, security access, etc.). Thereby, individuals are directed expeditiously to where services are needed (e.g., first responders, repair technicians, logistics, etc.).

### BACKGROUND

The present aspects generally relate to computer-based approaches for information mapping and routing and asset localization, and more particularly to approaches to routing informed by user mobility constraints and location through linked disparate maps to localized assets.

In business, facility management is the management of buildings and services. It is the role of facility management to ensure that everything is available and operating properly for building occupants to do their work. The facility manager generally has the most influence upon the quality of life within a facility. The information developed by a facility manager (e.g., private maps) are generally shared with others who need to access the facility in order to efficiently reach a desired destination. Facility management may range from the small scale (e.g. single small building custodial services) to the large scale (such as a campus of many buildings) or even on an international scale (e.g. global service provision to a multinational corporation). As such, managing operations and emergency responses for facilities of varying scales entails use of various location aids to manage these assets. Locating a particular building and outdoor infrastructure often requires use of geographic maps and navigation aids. Other types of facility management activities require the use of architectural or space planning layouts to locate particular places or objects within a particular building of a facility. Other types of services (e.g., delivery, repair) may require diagrams that predict what a user would experience when on site, such as locating a particular shelf or rack position. For each of these kinds of location related information, advances have made such data easily distributed and increasingly interactive. Facility managers avail themselves of various kinds of geographic, layout and asset tracking applications to create private maps and databases that each cover a portion of their responsibilities.

At the large scale end, interactive geographic information systems (GIS) are increasingly used for navigating to a desired location. GIS software deals with map based data, basically associating a wide range of data with location on a map. Associating data with location allows for new and effective means to analyze, correlate, and display data. Typically, GIS software allows for the overlay of data “layers” on a base map layer. Layers include aerial and space based information such as images, infrared and radar data; geological information such as composition, topology or seismic; demographic information, such as population and population characteristics; sensor acquired data, such as air and water quality; and a host of other information. GIS data is now used by business, governmental, and research interests to analyze and display location relevant data. GIS software has traditionally taken the form of platform based applications with very robust functionality for data creation, manipulation, analysis, and visualization. Navigation through a GIS depiction has become ubiquitous with increasing use of Global Positioning System (GPS) data and software algorithms that optimize a vehicle route of travel through a road map.

At the building level, various graphical office automation programs are capable of creating renderings of building layouts. Spreadsheet and relational database applications often inventory assets that are assigned to such buildings. With increasing computing power, architectural software such as Computer Aided Design (CAD) are available to more individuals responsible for facility management, increasing the precision and comprehensiveness of facility information that is available and can be shared with others who play a role in the operating a facility. Recently, information such as directory information (e.g., business, real estate, etc.) has been interactively cross referenced to geographic location so that assistance may be give to selecting the destination selected as well. Facility floor plans have even been oriented as a layer placed within GIS. This advancement has been focused on public map level of GIS development, rather than addressing the needs for private map development and integration at an individual facility.

### SUMMARY

The following presents a simplified summary in order to provide a basic understanding of some aspects of the disclosed versions. This summary is not an extensive overview and is intended to neither identify key or critical elements nor delineate the scope of such versions. Its purpose is to present some concepts of the described versions in a simplified form as a prelude to the more detailed description that is presented later.

In accordance with one or more versions and corresponding disclosure thereof, various aspects are described in connection with a facility map system that facilitates providing location-based information. A facility map model links a plurality of disparate map sources by a plurality of route elements. An object moving within a geographic scope of the facility map model is sensed and used by a location service component to suggest a route through the route elements across the disparate map sources. Thereby, a user is able to reach a moving object, or to change his route to a fixed location with the route adjusted as advisable due to changes in the route elements.

In another aspect, a computer-implemented method of communicating location-based information includes linking a plurality of disparate map sources with route connectors and route segments. Assets are located with the plurality of linked map sources. Then, a user is routed from a present position to a selected place via the route connectors and route elements, even though the map sources differ substantially in type.

In yet another aspect, a wayfinding device facilitates generation of a location-based service by comprising a means for defining routes and mobility constraints through a geographic road map and a facility map to a detail map within the facility map. A means for determining a current location of the wayfinding device and a means for determining a target location within a facility map object model are used in conjunction with a means for sensing a changed state affecting a route from the current location to the target location. Thereby a means for communicating a route to the wayfinding device advantageously avoids the changed state affecting the route.

To the accomplishment of the foregoing and related ends, one or more versions comprise the features hereinafter fully described and particularly pointed out in the claims. The following description and the annexed drawings set forth in detail certain illustrative aspects and are indicative of but a few of the various ways in which the principles of the versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

FIG. 1 is a block diagram of a facility map system.

FIG. 2 is a flow diagram of a methodology performed by the facility map system of FIG. 1.

FIG. 3 illustrates a facility map framework that manages and integrates a plurality of disparate map sources, assets, and positioning sources that provides location related services.

FIG. 4 is a flow diagram of a method of performing location related services pertaining to a facility map.

FIG. 5 is a diagram of a facility map framework system for performing the method of FIG. 4 to facilitate creating, hosting and using of private maps.

FIG. 6 is a diagram of the relationships between the facility map object model and other networked components of the facility map framework system of FIG. 5.

FIG. 7 is an architecture diagram of a facility map framework including the Facility Map Application Programmer Interface (FMAPI) of FIG. 6.

FIG. 8 is a diagram of map objects including layouts that form a facility map managed by the facility map object model of FIG. 6.

FIG. 9 is flow diagram of a method for authoring a facility map for the facility map framework system of FIG. 5.

FIG. 10 is a schematic block diagram of a portable handheld device according to one aspect of the subject invention for a user of the facility map framework of FIG. 3.

FIG. 11 illustrates a block diagram of a computer operable to execute the disclosed architecture authoring, maintaining or deploying location positioning services based upon the facility map framework of FIG. 1.

FIG. 12 illustrates a schematic block diagram of an exemplary computing environment in accordance with the subject invention.

### DETAILED DESCRIPTION

A facility map framework system facilitates creation of map and asset descriptions and integrates map information to form a facility map object model with defined connections and constraints between and within maps of disparate character (e.g., geographic road maps, facility floor plans, campus layouts, stacked vertical floor layouts, and cross sections in elevation (e.g., equipment positioning, storage location as viewed, etc.)). Routing through the object map is informed of a user's starting and/or current location, desired target, and mobility characteristics (e.g., disabilities, security access, etc.). Thereby, individuals are directed expeditiously to where services are needed (e.g., first responders, repair technicians, logistics, etc.).

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to concisely describe these versions.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more versions may be implemented as a method, apparatus, or article of manufacture using standard programming and/or engineering techniques to produce software, firmware, hardware, or any combination thereof to control a computer to implement the disclosed versions. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed versions.

Various versions will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various versions disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

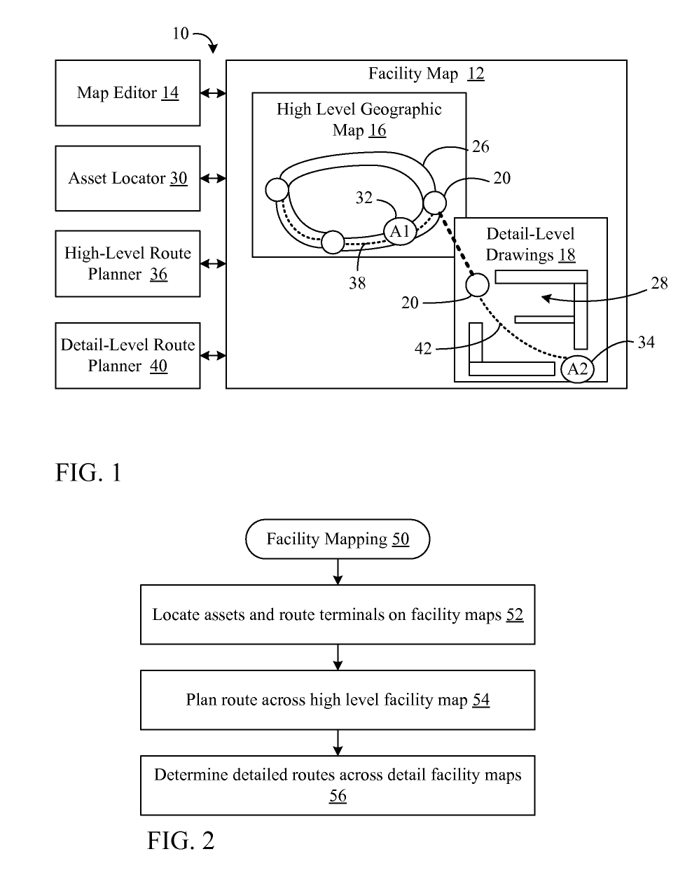

Referring initially to FIG. 1, a facility map system 10 addresses the needs at the facility, campus or enterprise level (hereinafter “facility”) with a facility map 12 that is integrated into a usable whole by map editor 14. In particular, high level geographic maps 16 are connected to detail-level drawings 18, as well as to other geographic maps (not shown) in order to provide a navigation space that transitions from road travel to foot travel. The map editor 14 defines the contents of the maps 16, 18, including connection terminals 20 and virtual links 22 between the maps 16 and drawings 18. The map editor 14 defines accessible paths 26 and accessible spaces 28 through the maps 16 and drawings 18. An asset locator 30 populates the facility map 12 with asset descriptions and locations, depicted as an asset “A1” 32 and an asset “A2” 34 on the map 16 and drawing 18 respectively. Assets can be subject to being moved within the facility map 12. A high-level route planner 36 provides navigation assistance through higher-tier portions of the facility map 12, such as a vehicle traveled geographic map 16, by providing an optimized route 38. A detail-level route planner 40 provides routing 42 through detail-level drawing 18 of the facility map 12 (e.g., building floorplans).

In FIG. 2, a methodology 50 performed by the facility map system begins in block 52 with locating assets and route terminals on a facility map. The assets can be items of interest that are to be managed or used within the facility. The route terminals constrain travel through the facility to reflect real-world constraints or obstacles. With the facility map prepared, in block 54 an occasion arises for planning a route across a high level portion of the facility map. The route reflects the constraints on travel and can be optimized accordingly. In block 56, upon reaching a target destination where other modes of travel are warranted, a routing is planned through detail facility maps, again reflecting the constraints for travel (e.g., security barriers, hazards, vertical translations, etc.)

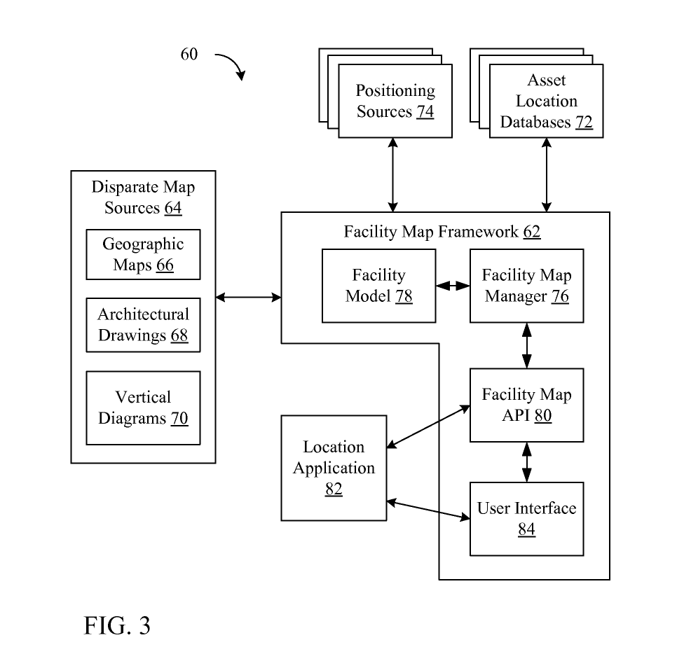

Referring to FIG. 3, a facility map system 60 leverages the integrated information incorporated into a facility map framework 62 to manage and integrate a plurality of disparate map sources 64 (e.g., geographic maps 66, architectural drawings 68, and vertical diagrams 70, etc.), asset location databases 72 related to places and facilities located within the disparate map sources 64, and positioning sources 74 that provide real-time positioning of persons and assets located within the scope of the disparate map sources 64. To that end, a facility map manager 76 authors and integrates the map objects (i.e., disparate map sources 64, assets location databases 72, and positioning sources 74) into a facility map model 78. A facility map application programming interface (API) 80 are provided so that a location application 82 can use the data within the facility map model 62 in order to interact with a user interface 84, which may be a remote communication device, to present location related solutions. The map sources 64 are disparate in that they differ in perspective (e.g., plan, vertical elevation, schematic, etc.), scale, type (e.g., geographic roadmap, facility floor plan, equipment/storage diagram, etc.) and source format (e.g., computer aided design (CAD), database, etc.).

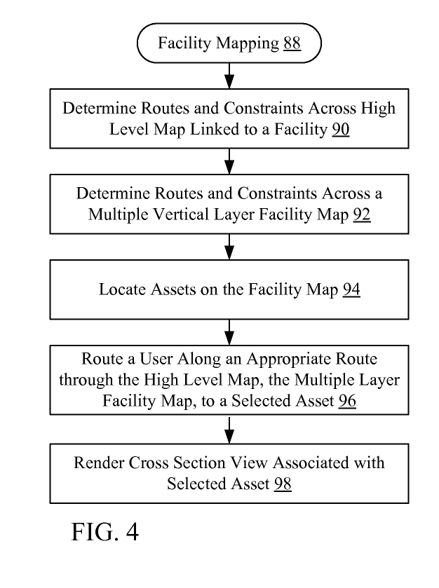

In FIG. 4, in another aspect a facility mapping methodology 88 performed by the facility map framework 10 integrates the disparate map sources by determining routes and constraints across high level map linked to a facility in block 90. The facility map model is further integrated by determining routes and constraints across a multiple vertical layer facility map in block 92. Assets are located on the facility map object in block 94. This locating is advantageously a combination of relative positioning within a map and location positioning sensing for certain persons or assets of interest that are subject to being moved within the map. With a facility map object thus integrated for use, in block 96 a user can be routed along an appropriate route through the high level map and the multiple layer facility map to a selected asset (e.g., equipment for repair, victim needing assistance, item for delivery, etc.) In block 98, this target asset is rendered in a plan view or in cross section elevation view in elevation associated with selected asset as required so that the user can correlate what they are seeing with the guidance being provided by the routing.

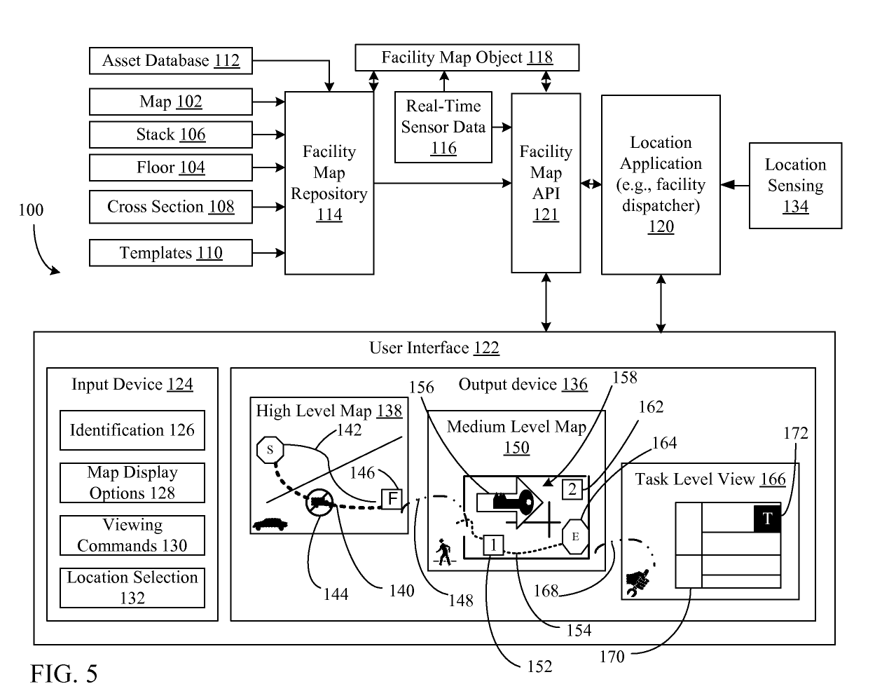

In FIG. 5, an illustrative facility map framework system 100 for performing the method of FIG. 3 facilitates creating, hosting and using of private maps for enterprise and Small Office/Home Office SOHO deployment (e.g., campus maps; building floor plans; laboratories, warehouse, and room details therein, to possibly include shelves, pallet bays, and computer racks. Such data may be created or imported in the form of maps 102, a floor plan of a building 104, a vertical stack representation 106 linking multiple floor plans 104 to form a multi-story building, a cross sectional representation 108 typically in elevation to show specific vertical and lateral orientation as viewed by a user. Templates 110 may facilitate creation of facility maps or room details, for example a cross sectional view in elevation of a server rack with a number of bays may be accessed. An asset database 112 cross references equipment, deliveries, etc. with reference to relative or geographic coordinates.

This data 102-112 resides in a one or more facility map repositories 114 in the form of a map object model 118. In addition, asset and person locations from real-time sensors 116 can be presented using the same format as the map object model 118 A location application, depicted as a facility dispatcher 120, utilizes a facility map application programming interface (API) 121 in order to access the information in the facility map object model 118. In some versions, the application 120 can interact with a user via a user interface 122, drawing upon the information in the object model 118 to render map and route depictions. The specific applications may include a computer aided facility management (CAFM) tool, location “dashboards”, delivery and service routing systems, etc. A user may utilize an input device 124 of the user interface 122 to manually input identification data 126, to set certain map display options 128, to change viewing commands 130 and to select locations (e.g., current location, target location) 132.

It one aspect, the user interface 122 can be configured to report transportation limitations or capabilities of the user data (e.g., disabilities affecting mobility, mode of transportation, security access privileges, etc.) that could be considered in routing. Features such as current location can be advantageously sensed or cross referenced, such as from a user-worn Radio Frequency Identification (RFID) device. Location data 134 may be autonomously maintained, such as by a motion detector (e.g., an inertial platform) (not shown), or supplied by a location sensor 134 (e.g., Global Positioning System (GPS), RFID receiver location, direction finding based on cellular wireless receiver, location of WIFI access point, etc.). The target data can be remotely assigned. User input may initiate acceptance of task to be tracked by the facility dispatcher.

In one aspect, a sequence of renderings on an output device (e.g., visual, audio, and/or haptic) 136 of the user interface 122 depict a first high level map 138 wherein a route segment 140 is selected by the facility dispatcher 120 as being optimum over a longer route segment 142. If a constraint of the user had been sensed in the capabilities data 128, specifically use of a large truck, a weight limit constraint 144 of the first route segment 140 would have prevented this route to a target facility “F” 146. Real-time location sensing may be available to render progress of the user toward the target facility “F” 146 or manual input may direct that a route connector 148 be triggered upon arrival at the target to render a medium level map 150, depicted as a building floor plan. A mode constraint may be assumed by this map depiction of travel by foot by individual “1” 152 depicted on a suggested lower route segment 154. Another constraint 156, identified for an upper route segment 158, is depicted as a key entry required for westward entry. The facility dispatcher 120 may render other asset identifiers, perhaps received real-time directly from other asset databases 160, illustrated by an Individual “2” 162, especially for applications in which multiple responders may be coordinating action. Upon reaching an end target “E” 164, the facility dispatcher 120 renders another map depiction 166 linked by a route connector 168. In particular, the map depiction 166 is illustrated as a cross sectional view in elevation of a storage template 170 holding a target item “T” 172 at an upper right shelf. In addition, a user can select map views through viewing commands 130.

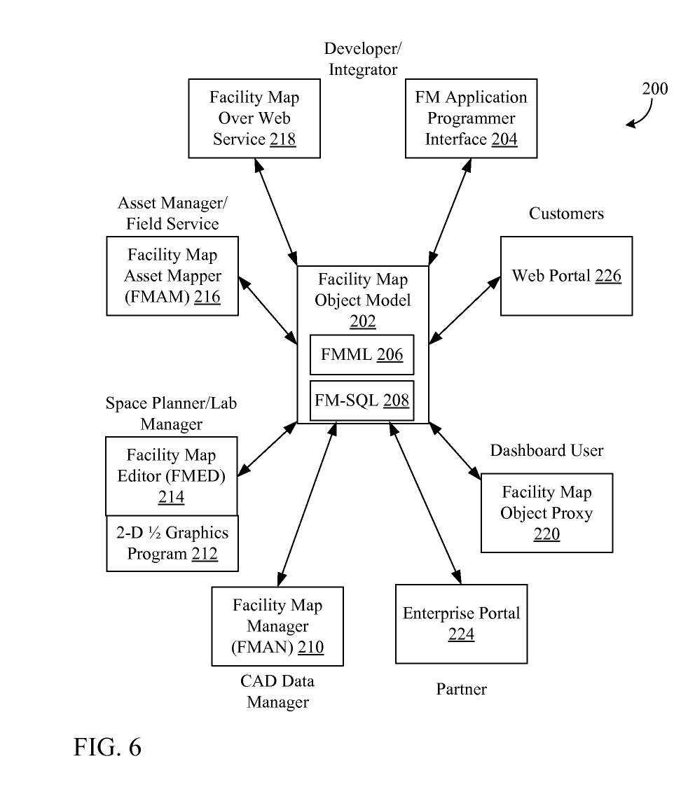

In FIG. 6, an exemplary aspect of a facility map framework 200 provides for the creation, deployment, and utilization of maps of private facilities such as campuses, buildings, rooms, and shelves. A new facility map object model 202, which illustrates an implementation of the object model 118 of FIG. 5, is embodied in an XML schema and other forms (MICROSOFT VISIO and SQL), as well as in a FM Application Programming Interface (API) 204. With this model 202, many sources of location data can be integrated, including CAD drawings, facility management data, space occupancy data, and object and person locations from real-time sensors. Applications using the API 204 can access this data in a uniform manner, including seamless integration across multiple maps from different sources, so that a single comprehensive map view is communicated to the user. These maps can be used for route planning and wayfinding, as well as for dashboards that allow query and control of specific objects portrayed in the map.

The Facility Map Object Model (FMOM) 202 is an abstract model of facility maps, designed to allow many disparate systems and functions to be unified and integrated. It serves as a common vocabulary and framework for data representation and interchange, and for seamless presentation to users through map renderings. Various information sources may utilize subsets of FMOM 202 to present relevant data. This leads to a very flexible concept of a “map”, which can include a CAD drawing; a sketched drawing; a list of place names; a list of assets and their locations; a bitmap image; etc. FMOM also represents a limited set of semantic features, particularly for map drawing, route planning and wayfinding, and cross-map relationships. Additional data can be represented in FMOM 202 through annotations on map objects; or it can be contained in external data stores, accessed through mechanisms that are defined in the FMOM model.

Facility Map Markup Language (FMML) 206 is an expression of the Facility Map Object Model 202 as an XML schema. An FMML document can be stored as a file, which may be accessed directly or through an FTP server; soap web service, or it can be communicated directly from one application to another.

FMML documents can be created from CAD or VISIO drawings using a Facility Map Editor (FMED) 214, and from any application using the Facility Map API 204. FMML 206 can be easily read and processed by applications using the Facility Map API 204. Facility Map SQL (FM-SQL) 208 is a schema for the representation in part of the Facility Map Object Model 202 in a SQL database in one version on SQL Server. An FM-SQL facility map can be created through a Facility Map Manager (FMAN) 210, or by an application through the Facility Map API 204.

The Facility Map Manager (FMAN) 210 is a program for establishing and exploring map relationships. The basic approach is to consider each map as a node in a graph, with binary map relationships forming the arcs of the graph. Examples of functions of FMAN 210 include, but are not limited to managing the deployment of maps (e.g. FMML files), including authoring, versioning, staging, history maintenance, creating a directory of maps, etc.; creating overlays in which a new map defines regions or places of interest, that are defined through features or coordinates on an existing map; aligning maps, such as the aligning the floors of a building, aligning a building map to a campus map, aligning a building or campus map to the Earth, or creating an “exploded” view of a stack of maps; establishing map hierarchies, such as campus to buildings, building to floors, floor to rooms, room to room detail. Some of these relationships may be captured within a single map (e.g. building to floors to rooms); then FMAN 210 can be used to establish the other relationships; and connecting maps through semantic relationships and travel routes.

In one illustrative implementation, creation of a facility map can be done in a two-dimension plus limited three dimension (“2½ D”) graphics program 212 augmented by standard representations that define the objects, connections and information between the various map objects. In the illustrative version, facility maps can be created in 3D graphics program 212 similar to MICROSOFT VISIO, referred to hereinafter as Facility Map—VISIO (FM-VISIO) software, which is a schema for the representation of the facility map object model 202 as a VISIO drawing. In FM-VISIO, all the data except the actual polygons are stored in the form of user cells on VISIO drawing shapes. In addition, there are shapes specifically inserted into the drawing to act as data holders for important information. FM-VISIO is normally created and used specifically by the facility map editor (FMED) 214, which supplies stencils that contains shapes and commands for creating facility maps.

A facility map can originate as a VISIO floor plan drawing, or as a CAD drawing that is imported into VISIO, or through a sketch drawing made directly in VISIO. The user then opens the FMED 214 stencil in VISIO, and drags “Information Blocks” and “Authoring Marks” as needed from the stencil onto the drawing. Each information block and authoring mark can be clicked to open up an information dialog, and all necessary data can be entered into these dialogs. FMED 214 will store all the information in user cells, thus converting the drawing into an FM-VISIO drawing. Information Blocks can be grouped with shapes on the drawing to indicate that they contain information about those shapes; Authoring Marks are self-describing. Examples of data added to a drawing through FMED 214 are naming and identification of shapes; describing the type for each shape (e.g. room, corridor, etc.); annotations on shapes; links between shapes; and the appearance of shapes in map renderings of various kinds.

FMED 214 also has auto connect, auto stack, and auto explode features. AutoConnect is a feature to automatically create cross-references between elements of a routing network, and other routing elements or places. In the AutoConnect feature, the map author draws in the route segments or route connectors, then performs an AutoConnect operation on these elements. The AutoConnect operation does the following: (1) places new route connectors wherever route segments intersect; (2) connects [i.e. creates cross-references between] route connectors and the route segments that touch them; (3) connects route segments and the places that contain them; (4) connects route connectors and the places that contain them [if those places were not connected to any route segments in step 3]; and (5) connects route connectors and the nearest route segment, in places that contain both. AutoConnect also recognizes “open space” places, that create connections between all touching route connectors (e.g. a building lobby or other space that allows relatively free travel in all directions). AutoStack is a feature to automatically create a “stack” representation of the floors of a building, by creating a new elevation layout that contains all the floors in order. AutoStack takes a drawing file that has multiple pages representing the individual floorplans; and it creates a new page in the file that represents the stack view. AutoExplode takes a stack view drawing, and creates an “exploded” view that shows all floors of the building, as seen from an oblique or overhead view, laid out on a single drawing page. AutoExplode can be applied to a stack layout page to create the Exploded view layout—the stack layout page may have been created by the AutoStack operation, or through manual drawing activities.

Facility Map Asset Mapper (FMAM) 216 is a suite of components to facilitate the creation of asset rosters, which are lists of assets and their locations. Asset rosters can arise from many sources, and FMAM 216 implements two aspects—a desktop aspect for creating a roster from an external record, and a field aspect for a field worker to record the locations of assets in the field. FMAM 216 can also be used for editing existing asset records, and for maintaining a record of sites on the route of a field data collector, including sites visited and not yet visited.

Facility Map Over Web Service (FMOWS) 218 is an interface specification for an XML Web Service, typically accessed through Simple Object Access Protocol (SOAP), to provide facility maps. An example for accessing an FMOWS Server 218 is a client application that requests a map from an FMOWS Server 218, and the Server provides the map in the form of an FMML document. FMOWS server 218 can provide several other services, such as a map from an FMOWS Server 218 that can include an “expiration” date/time. After expiration, the client may request an updated map from the server, supporting real-time updates of maps. A request can be posed over a subset of a map, possibly for a specific individual object. A request can be posed for specific map information about one or more objects, such as current location etc. The FMOWS Server 218 can be instructed to generate events in response to the movement of specified map objects into, out of, or through specified locations.

Any application that uses the FMAPI 204 can act as an FMOWS client in the simple model, simply by following any cross-reference that points to a map from an FMOWS Server 218. To use the expiration feature, the subset feature, or the eventing feature, the application can use features of FMAPI 204 that are specifically for building FMOWS Clients.

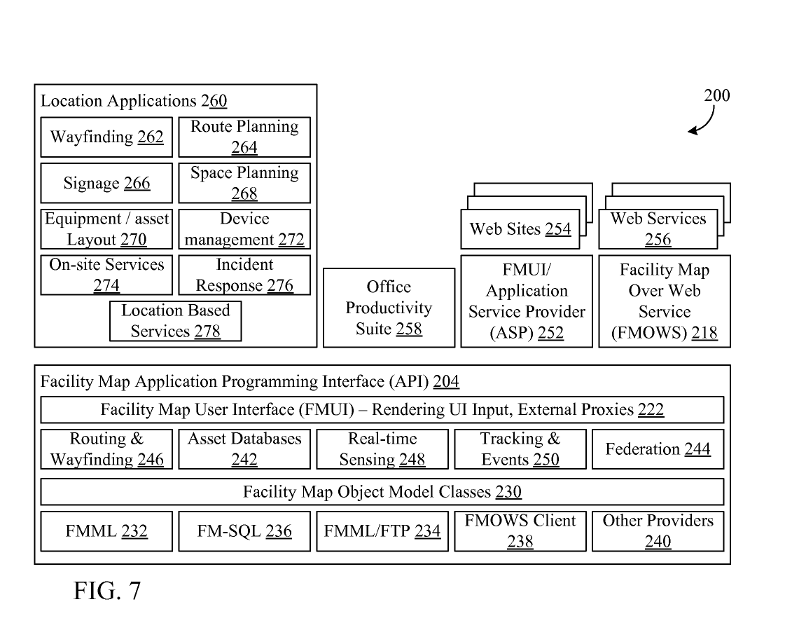

Facility Map Object Proxy (FMOP) interface 220 serves as an interface to a dashboard user, allowing a queries and control of individual objects portrayed on the map as icons, drawings, images, etc. In the facility map framework 202, this is accomplished by creating a web service for a set of objects that fulfills the Facility Map Object Proxy (FMOP) interface 220. Applications using the Facility Map User Interface (FMUI) 222 (FIG. 7) can invoke the web service when the user clicks or right-clicks on the objects in question. Enterprise and web portals 224, 226 can deploy facility maps to partners and customers respectively as a directory of files, through an FTP Server, as FM-SQL databases, or through FMOWS web services.

In FIG. 7, an illustrative architecture for a facility map framework 200 built upon the Facility Map Application Programmer Interface (FMAPI) 204 is depicted. One implementation of FMAPI 204 is a C# Software Development Kit (SDK) for creating and accessing maps in the facility map framework 200 and contains several layers. An object model layer 230 is a set of object classes that embody the Facility Map Object Model (FMOM) 202 in C# form, with additional links and bookkeeping to facilitate application development. The FMOM layer 230 includes resolving cross-references, overlaying information from multiple maps, and looking up references to prototype objects. Below the object model layer 230 is a set of facility map providers that can instantiate an object model from various sources. These include an FMML file provider 232, FMML files accessed through FTP 234, FM-SQL databases 236, FMOWS Servers 238, and other providers such as those files accessed directly 240. FMAPI 204 can cache maps fetched through FMML file provider 232 and FTP 234 in local XML files, reducing need for network connectivity and traffic when repeatedly accessing the same facility map. Above the object model 230 are a number of “engines”, including name and ID lookup (asset databases) 242, federation across maps 244, routing and wayfinding 246, sensing update of real-time maps (via FMOWS) 248, and generation of events based on map object motion (tracking and events) 250.The top layer is the Facility Map User Interface (FMUI) 222, a package of rendering and UI capabilities in several forms including a renderer for bitmaps and Windows .Net controls; a .Net control and a .Net Compact Framework control; and an FMUI Application Service Provider (ASP) renderer 252 for browser-based UIs (web sites) 254. Also, the FMOWS 218 supports web services 256. Other office productivity programs 258 may build upon the information accessed via the FM API 204.

The Facility Map API 204 renders a depiction based upon the FMOM 202 as specified through a presentation (not depicted), which has these elements: a base layout used to establish the coordinates and extent for the drawing; a set of layouts whose map objects will be shown in the drawing; each must have a transform to the base layout, or else the map objects that will be drawn are only those that define a location on the base layout (or a layout with a transform to the base layout); and a set of appearance styles to apply to the map objects. Appearance styles are specifications for drawing optional lines, optional fill, optional text label(s), an optional embedded drawing, and an optional icon or image. A style also indicates one or more specific map objects to which it will be applied. Each map object can have its own style; or if it has no style applied, then its prototype will be consulted to see if there is a style applied to the prototype. Normally, a presentation will include styles applied to prototype objects, for example a style applied to the “room” prototype object will implicitly apply to all specific room objects that specify “room” as their prototype (or their prototype's prototype, etc.). If it is desired to highlight an object, then an additional style can be applied to that specific object, which will take precedence over the style applied to the prototype. Conditional views and styles depend on the size of the drawing, object property values, and/or whether object is “select” or not.

Styles are normally grouped into named views in FMOM 202, i.e. in an FMML document, FM-SQL schema, FM-VISIO drawing, etc. These views are stored in layouts. Each view has a name and a set of styles; the view with no name (null string) is called the “default view” for its layout. An application may create a presentation by specifying a view name for each layout, which specifies the styles to be applied to that layout. Presentations perform a considerable amount of pre-computation before actually generating a rendering. Subsequent renderings can perform an abbreviated pre-computation if the styles (appearances) change but not the object locations; or if the object locations change but not their styles. Recording the style and view data in the FMOM data 202 allows multiple applications 254, 256, 258, 260 to access the same map data and produce drawings, without requiring any additional information. Each application can also access multiple map sources without needing any external or prior data about the map source data.

The FM API 204 of the facility map framework 200 is designed to support a number of location applications 260, for example wayfinding 262, route planning 264, signage 266, space planning 268, equipment/asset layout 270, device management 272, on-site services 274, incident response 276, and other location based services 278. Such location applications support a number of scenarios, such as asset location, including people, either as specified or within a specified location. All these are variant queries against an underlying representation of asset identities and locations. When the assets in question are people, there arises a privacy concern in the distribution of information about an individual's location and movement. The means of addressing this concern may vary from one enterprise to another and from one application to another, but in all cases, the map framework 200 can address the concern. In addition, when an object has been assigned to an individual person, then information about that object can also fall under privacy protection.

Another scenario support pertains to asset detail about an asset shown on the map, or indication presented about a detail of interest (e.g. color of icon indicates status of asset). The UI 222 can give the ability to actually control the asset's settings or actions. These are variants on an underlying representation that builds on the asset map, to additionally provide the capability to invoke functions external to the map itself, pertaining to individual assets. With this capability, the map can be used a graphical “dashboard” to visualize and control a collection of assets.

Another scenario supported can be place information, such as locating to a specific named place, locating a place corresponding to a specific type of place, or other places associated with a specified place. In addition to “assets” at a given place, there are some intrinsic characteristics of places that may be of interest. These can include assignment or ownership, usage, history, and other information available in external sources such as CAFM databases. Links to other related places are also of interest, for example zooming in and out of a building or room, and viewing the different floors of the same building.

Routing and wayfinding can be a supported scenario, providing how to get from one place to another place, or to a specific or type of asset, including the shortest path to a set of assets of a certain type. Routing refers to finding the shortest path from one place to another, possibly by a specific mode of transportation, possibly with a specific set of credentials (e.g. keys or ID cards), and possibly subject to other constraints (such as fewest changes in direction). Wayfinding refers to communicating to a person the instructions for following a given path, possibly given a specific set of circumstances, possibly given the person's current location and/or facing, and possibly given a set of cues that can be provided. There are composite capabilities based on these, such as finding an optimal route to visit several places, or an optimal placement of goods or other assets, based on the route geometry as well as other factors. “Nearest” can refer to nearest to a place, or to one of a set of places, or to a given path. The map framework 200 can provide paths and look up cues. However, for many applications, there are constraints outside of the map framework 200. In these cases, the application may need to drive the process of constrained routing, invoking the map framework 200 from time to time to evaluate the geometry and travel criteria for specific candidate route segments.

Another scenario supported can be incident response at a certain place that needs to be identified, shown in a map context, with information provided about the location and assets in the vicinity. The role of people in the vicinity can be determined (i.e., other responders, other victims, witnesses/bystanders, etc. The entrances, egresses, and travel chokepoints around that place can be provided. Calculations can be made for dispatching and estimating arrival of a particular subset of the responders who can be routed mostly quickly to a particular place, given these routes and constraints. Incident response is a generic template for a set of map-based queries that arise when an incident of interest has occurred. It arises in one or more forms, in virtually every application domain included in the survey. The queries in incident response are composites of the more basic query capabilities outlined in the generic scenarios above, so incident response does not introduce new modeling requirements; rather it adds a new layer of usability requirements on top of the basic “engines” of the map framework 200.

To illustrate how the facility map framework 200 facilitates such uses, the following three examples are given. First, a visiting technician is required to perform service on a computer component in a rack in a lab within a facility. This technician has several map requirements: The map of the world is needed to smoothly connect to a campus map with a driving route that continues from one to the other seamlessly. The campus map connects to a map of the destination building and its parking lot. In this map, at the parking lot, a transition is made from driving to walking. Alternative walking routes are presented, based on the availability of credentials (e.g., green route is shorter but requires a cardkey; blue is longer by going through the reception area, but it requires no cardkey). Inside the building, the walking routes continue. The walking routes merge at an elevator on the first floor. The route continues to the destination floor. On this floor, there is a detail map of the destination lab. While the building map and campus map are maintained and provided by the enterprise real estate department, the detail map for this lab is maintained and provided by the group lab manager. Yet, to the technician, the presentation is integrated and seamless. The route continues into the lab room, and up to the target computer rack. There, the map view can be shifted to see the detail of the rack, showing the components, and highlighting the component that requires service. The rack models themselves are instances of a generic template for the given rack size; this saves the lab manager from having to specifically draw each rack model from scratch. The component locations may have been entered by hand, or may have been acquired from a batch or real-time asset tracking sensor system. An alternate view might be to see the front view of several adjacent racks at once, to give better context information to the technician, again with the component in question highlighted.

As a second illustration of a use of the facility map framework 200, warehouse operation can be enhanced by presenting integrated information from several sources: A back-end database stores static information, such as the location of RFID beacons, and the zones for goods placement within the warehouse. An active RFID location system tracks moving assets such as equipment and key personnel. A passive RFID system scans the RFID tags on pallets as they move through chokepoints such as dock doors, and while they are being carried on a forklift. The integration of these systems allows inferences about location, such as the current location of each pallet. Even when a pallet is not currently scanned by any RFID system, the last known location when it was carried on a forklift is stored as the current location of the pallet. Cross-section views (above) show the forklift operator which bay to use for the next operation. The map display also serves as a dashboard for device configuration (above), status query, and messaging. The map can be linked to Line of Business (LOB) software, for example an invoice could be brought up for display by clicking on a pallet on the map. The map can be used for planning goods placement, and for route planning and on-line traffic control. Unexpected location events, such as a fork life placing a pallet in an unusual spot, can be detected and can trigger alerts. A history log can be used for later analysis, for example for optimizing goods placement or vehicle route channels.

As a third illustration of a use of the facility map framework 200, a first responder is required at a facility described by the facility map framework 200. In this scenario, a disaster in a building has led to the need to rescue a victim. The victim's location is assumed to be known through some unspecified means, such as a statement from another victim, or perhaps a location sensor of some kind. The first responder has several map requirements: The map of the enterprise facilities (campus, building, room detail) is hosted in a standard format so that the responders' software, which is independent of the enterprise, can nevertheless read and display the map data. This includes presentations from sensors, security devices, etc. within the enterprise. Security devices, such as door locks, are indicated so that the first responders can apply tools, or coordinate with enterprise operations staff, to obtain entry as necessary. The map should show the victim, the first responder in question, and other nearby responders. As before, the route must proceed smoothly from outdoors to indoors, and across floors of the building (using stairs rather than elevators, for example, if the disaster has made the elevators unsafe). Sensors in the building are depicted for the first responder and can be queried by clicking on the map to determine their status and environmental conditions. Clicking on a video camera, for example, could bring up a window with a live display of its video feed. For example, if a sensor detects a dangerous area, the corridors around it are marked in a manner to show the impassability and the routes suggested adjusted accordingly to avoid passing through the danger area. Because of a blockage, Routing may be advantageously assigned to a first responder able to reach the victim the quickest, rather than the physically closest first responder. If possible, the responder's direction of facing is shown, perhaps supplied by a carried compass. This will help the responder orient to the map display, and also can help in communication with outside coordinators who might have additional information to supply. The location information and sensor readings are updated in real-time. The enterprise information and responders' operational information are coordinated and overlaid on the display seamlessly. For example, the responders might bring their own quick-setup location beacon system to deploy at the site, providing responders' locations. This beacon system can be rapidly calibrated to the building map so that the responders' locations can be accurately overlaid on the underlying building floor plan.

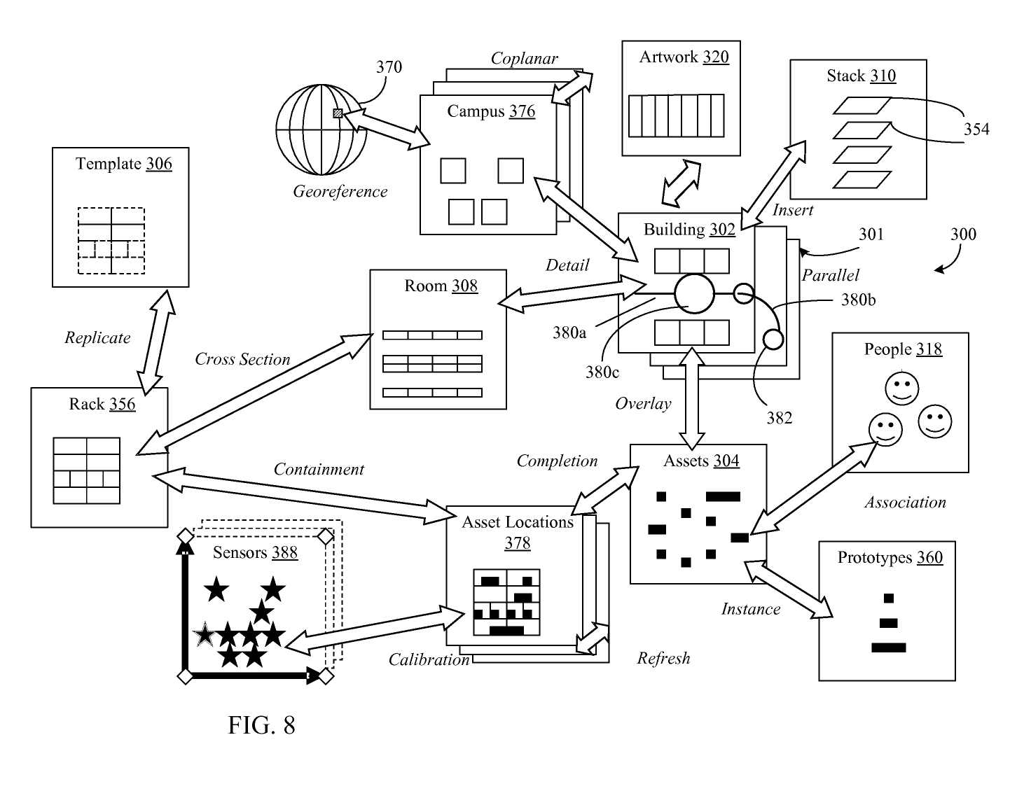

In FIG. 8, a map suite 300 is a set of layouts representing locations, places and assets. A facility map 301 is a set of layouts treated as a single unit for storage and loading. Examples of facility maps 300 include one complete building, including all floors of the building, or a map of single campus. A facility map suite 300 consists of some data about the facility map suite 300 itself, and a collection of zero or more layouts. A layout is a single dataset within the facility map 301 (i.e., single sheet, page, of drawing), with an example depicted as a floor plan layer 302 for a single floor of a building. A layout need not be geometric, such as an asset layout 304 that could contain a plurality of office automation equipment scattered throughout a building.

A layout can have any of several drawing types. The floor plan layout 302 is an example of a plan layout that is a top-down view, in which the layout defines a coordinate system. That coordinate system has an extent in X and Y. The directions of the axes, units of measure, and numeric range of coordinates, are defined in the extent model. Another layout type is an elevation layout that is a horizontal (e.g. front) view, in which the layout defines a coordinate system through an extent (as for a plan layout). A set layout, such as the asset layout 304, is a list of map objects and does not define a coordinate system. A template layout 306 is a list of map objects that are abstract prototypes, i.e. they do not correspond to specific real objects. An example would be a layout that defines generic “room” and “corridor” objects that are not real places, but can be used as prototypes by actual objects in a plan layout. A schematic layout 308 represents a system in the form of a drawing, in which the coordinates are strictly used for graphical layout. A schematic layout 308 has an extent, which defines the drawing surface, but coordinates cannot be used for calculations such as travel time. Actual geometric relationships in the world may be established through a transform to a plan or elevation layout, or through notations attached to the individual objects in the schematic layout 308. A stack layout 310 represents a symbolic front view of a building, assigning a sequence to the floor plan layouts 302 of the building floors. Coordinates in a stack layout 310 are used for drawing an illustration of the stack, but generally have no physical significance.

Set and template layouts 304, 306 do not define coordinate systems. If the objects in a set layout 304 have location polygons recorded, those polygons must indicate a plan or elevation layout in which the coordinates exist. The objects may also name locations instead of, or in addition to, specifying polygons. Objects in a schematic layout 308 may indicate distinct location polygons in the schematic layout 308 itself, as well as in a plan or elevation layout.

A layout consists of some data about the layout, as well as zero or more lists of map objects, such as the following: Places are location elements, typically with geometry defined on a plan or elevation layout. Cross references to locations can only point to places, but not to other map objects. Assets 304 typically represent specific physical objects or resources, and are perhaps associated with external proxy services to provide more detail or control capabilities. Persons 318 represent people, treated as assets with additional provisions for personal privacy protection. Artworks 320 are graphical markup that is typically displayed on a drawing of a layout 302, but has no semantic meaning in the map, with an example depicted as an arrow drawn on a stairway to indicate the direction of travel away from the current floor.

Authoring marks (not shown) are objects, typically drawn graphically during the map authoring process, that contain information specifically for use during later steps of map authoring. They do not have specific semantic meaning for applications, though various data properties of the layouts etc. may have been computed from the authoring marks before the application reads the map. Authoring marks include geomarks, registration marks, compass marks, scale marks, cross-section marks, and calibration marks.

In addition to the defined features of map objects, additional annotations can be added. Properties are a set of name/value pairs, where the value is either a string, or a reference to a map object, or a list of properties. By embedding a list of properties, a developer-defined “sub-object” can be defined within a map object; this is expected to be the primary means for vendors to implement vendor-specific extensions to the facility map 301.

Map objects can be identified for two primary purposes: (1) Inquiries from a user, for example finding a room based on its building and room number; and (2) resolution of cross-references, from other map objects and/or from external sources (e.g. someone emails you a cross-reference to a map object). In the facility map 301, map objects can be identified in either or both of two ways—by Name and by identifier (ID). Both are treated as uninterrupted strings. A map object can have zero or more alternate names as well as its primary name; when looking up a map object, all the names are treated equally and any can be used to identify the map object. Each facility map 301 and layout 302-310 may define a dictionary (not depicted) for names and/or a dictionary for IDs. This is simply a lookup table for finding objects by matching the key string (name or ID). Alternate names are entered into the name lookup table. All key strings in a given dictionary must be unique; a duplicate key string will not be entered into the dictionary, and may cause a program to fail.

In some cases, facility maps 300 or layouts 302-310 have a hierarchical relationship of dictionaries. In the most common situation, a composite map may receive name or ID lookup queries, and the map objects referenced may actually be defined in other, subsidiary facility maps or layouts. In the Facility Map Framework, this is facilitated by allowing both the name dictionary and the ID dictionary to include Dictionary Delegates, which are references to other facility maps and layouts, with a matching pattern for each delegate. When a name or ID doesn't match anything in the dictionary, the delegates are consulted. If the name or ID matches the pattern associated with a delegate, then the name or ID string is passed to that delegate for lookup. There may be a transformation applied to the name or ID before it is passed to the delegate. For example, if a campus map receives a query for “A/207”, it may have a delegate for Building A with the pattern “prefix is ‘A/’” and the transformation “remove the prefix”—then, the string “207” would be passed to the map for Building A for resolution.

References (not depicted) to facility maps 300 and map objects 312-324, which may form a cross-references from one map 301 or map object to another, include an optional name or ID of the facility map 301 or map object 312-324 being referred to. References include an optional name or ID of the layout 312 whose dictionary must be consulted to find the map object 312-324 in question. References also include an optional specification for the facility map 301 that must be consulted to find the map 301 or map object 312-324 in question. The specification includes a source type, which is a string indicating the type of facility map provider used to load the map in question. Examples are “FMML”, “FM-SQL”, or additional providers, each with its own source type string. The specification further includes the source, which is a string given to the facility map provider to indicate the specific map in question. For “FMML” this would be a filename (path); for “FM-SQL” it is the database server and database name; for “FMOWS” it is the uniform resource locator (URL) of the web service. References further include an optional string called the source data that is passed to the indicated source to provide additional access information (e.g., user account name and password used to authorize the access to the specified map). Specifications also include an optional name or ID of the specific facility map 301 in question.

A reference becomes a pointer to a target through the process of resolution. In the resolution process, a determination is made as to whether this same reference has already been resolved to a target; if so, there will be no further action. If not, then resolution will proceed. If a source map is specified, the appropriate provider is contacted, giving the appropriate provider the specifications above, to fetch the facility map. Typically, the provider will cache each map that is fetched, so that a later fetch of the same map 301 will not require actually loading the map again. Then, if a layout 302-310 is indicated, that layout 302-310 will be retrieved from the given map. Finally, the map dictionaries and layout dictionaries will be consulted to discover the map object in question. If the name or ID doesn't match anything in the given dictionaries, then all the delegates of those dictionaries will be consulted to discover if the lookup needs to be resolved by a different facility map or layout. If so, a reference to that other map or layout is created and resolved by applying the above procedure. A reference can be expressed as a text string, so it can be stored in a document or web page, communicated between users in an email, stored in a database, etc.

References are “self-describing” in that they include the type of source for the facility map 301. By adding appropriate providers, a reference can be made to data sources that are completely external, for example a GML file or a facility map 301 generated automatically from a text file, spreadsheet, or drawing. An alternate approach would be to create a web service server to wrap such external map sources, fulfilling the FMOWS interface. Because a reference can point to an object in the source map or any other map, references allow map content to be spread across multiple maps without affecting the semantics of the relationships involved.

A link is a reference with a link title for the reference, and an optional link description. The name is used to indicate a name that can be given to a user, for example, to indicate the purpose of the link and what the target is. The description is a short text string that might pop up in a user interface, for example, to give the user a better idea what the target is and/or how it is related to the current display.

Each map object 312-324 has three kinds of links it may define: zero or more context links, zero or more detail links, and zero or more associate links. A detail link is typically a reference to a layout 302-310 or map 301 with more detail about something, for example a link from a room in a floor plan layout 302, to a layout that gives detail for the room. A context link is the inverse—a link to a map object that gives a view of a larger extent around a location. So, from a floor plan layout 302, the place for a specific room might have a detail link to a layout that describes the room contents; a room contents layout could have a context link back to the corresponding room map object on the floor plan layout. An associate link connects aspects of the same thing, for example a person may be an associate of a place that represents what the person is carrying.

In the illustrative version as previously mentioned, a facility map 301 is authored in predominantly two-dimensional with some aspects bearing three-dimensional characteristics (“2½ D”). In particular, coordinates are represented in two dimensions with an option to define a minimum and maximum bound on the third dimension. Each polygon can similarly define a minimum and maximum value for the third dimension. However, individual points are only two-dimensional. It should be appreciated that a full three dimensional representation may be used in some applications. Two types of vertical structure that are semantically linked to plan views in the facility map 301 are called stack layers 310 and cross-section layers. A stack layer 310 is a model of a building as an ordered sequence of floor layouts, from the lowest to the highest. A stack layer 310 is represented as a layout (with the “stack” drawing type), in which each place corresponds to a floor. Each of these places defines a layer name, which is used when making a list of the floors in the stack; and a layer index, which is a number indicating where this floor is in the stack (lowest to highest index=lowest to highest elevation); also there is a detail link to the layout that defines the floor. Each layout that corresponds to a floor in a stack has a stack layer reference to the corresponding place in the stack layout. Note that a single floor layout may participate in multiple stacks—the floor layout would have multiple stack layer references, and each of the stack layouts will have a place 354 representing this floor.

A cross-section layer is an orthogonal view that details a place or a set of places from the side, top, etc. Typical examples would be the front view of one or more shelves, or the front view of one or more computer racks. The layout for the floor plan, which indicates the top view of each shelf unit or rack with a place, would have a cross-section for each shelf or group of collinear shelves, depicted as rack 356. A cross-section is indicated during the authoring process by placing a cross-section mark in the base drawing, aligned with the X-axis of the orthogonal view. The Y-axis of the orthogonal view will be the same as the Z-axis (i.e. out from the drawing plane) in the drawing.

A cross-section mark defines zero or more Detail Layouts, which are references to layouts that define the details of the cross-section view. Typically, the base drawing is a plan layout (top view), and each detail layout is an elevation (front view). The cross-section mark may also specify zero or more places detailed, which are specific places on the base drawing that are expected have detail links to specific places in the detail layout(s). The cross-section mark can also indicate a detail master layout, which is a layout used as a template when generating detail layouts during the authoring process. An example would be the template layout 306 that shows a generic computer rack of a given size that is used as a template to stamp out detail layouts for all actual computer racks of that size.

The facility map 301 has two mechanisms for specifying an underlying model for a map object—prototypes 360 and is-references. Prototypes 360 form a class/subclass system for map objects. Technically, a prototype 360 is a reference to a target object that is consulted whenever a property is desired that is not defined in the referring object. For example, a specific room place object may have a prototype that is a generic room place object in a template layout. There can be multiple levels of prototypes, for example a “conference room” place prototype could have a “public room” prototype, which in turn has a “room” prototype. Prototypes 360 can define properties that are then implicitly apply to all objects that use this prototype 360, unless those objects override the prototype by defining the property explicitly. Second, the appearance of a map 301 may be specified by creating view styles that apply to the prototype objects, which are then applied automatically to all objects using each prototype.

Each map object may also define an Is-Reference. An is-reference is an assertion that this map object does not have an independent existence; it merely exists as an alternate way to create a reference to some other object (the target of the is-reference). Any time a reference is resolved to this map object, the resolution proceeds on to the target of the is-reference. Thus, applications do not normally resolve a reference to yield an object with an is-reference; when they attempt to do so, they receive instead a pointer to the object targeted by the is-reference. An example of the use of is-references would be to create a lookup service defining a set of GLNs (Global Location Numbers) as defined by the GS1-US standards body—this would be a facility map, probably presented through an FMOWS Server, with a single set layout, in which each object is a place, whose ID is the GLN, and which has an is-reference to the place referred to by that GLN. Then, a client application could connect to the server and perform a lookup using the GLN as the object ID, to retrieve the facility map and map object indicating the place referred to by that GLN.

Each map object can have its location by an In-Place reference, or by a Polygon. An In-Place reference points to a place or layout, and represents the assertion that the object is somewhere within that place or layout extent, but at an unknown or indeterminate location.

A polygon is a set of XY coordinates, normally defined within the layout that contains the map object. However, if the polygon is defined in the coordinates of another layout, that can be indicated through an In-Layout Reference in the polygon. A polygon can represent a point, line segment, or a polygonal arc (“outline”) or polygon (“fill”).

Plan and elevation layouts define coordinate systems with extents such that coordinate systems can be aligned with each other through transforms that are stored in layouts. Each transform indicates a target layout, and a two-way mapping between corresponding coordinates in the containing layout and the target layout. Applications use these stored transforms. In the authoring process, however, such transforms may be derived from various constraints. Registration Marks are authoring marks (described above) used to align parallel or coplanar layouts, for example a building onto a campus map 376, or the first and second floors of a building. Each registration mark has references to one or more registration marks on other layouts; the presence of two or more such marks allows a layout transform to be computed.

For georeferencing (transform to latitude/longitude), different types of authoring marks can be used, depending on the a priori information available. A geomark associates a point with latitude and longitude coordinates; a scale mark establishes the unit of measure in a layout; and a compass mark aligns layout directions with true North. A transform to latitude/longitude can be established by two or more geomarks, or by one geomark plus a compass mark, along with either a scale mark or a unit of measure recorded in the layout's extent (see above). In the illustrative version of the facility map 301, the Earth is represented by a layout 370 named “WGS84”, in the “Earth” facility map from the “FMF” map provider. The Facility Map Editor (FMED) can be used to insert authoring marks into an FM-VISIO drawing and the resultant FMML file. The Facility Map Manager (FMAN) can compute the transforms from these authoring marks, or from an interactive map alignment interface. FMAN can then store the resulting transforms into the FMML files.

Layouts can have several kinds of composition relationship related to location. In an overlay link, a layout that defines places can indicate a layout containing assets or other map objects defined in those places (e.g., asset locations layer 378). The layout with those objects would have an underlay link back to the layout with places. If one layout is mapped onto another, the outer layout may have an Insert link to indicate that it is considered to include the inner layout, and the inner layout may have a corresponding Frame link to the outer.

The Facility Map API 204 includes a route planning capability based on route elements in the FMOM 202. Route elements include route segments 380, which represent paths of travel, and route connectors 382, which are junctions between route segments 380. There are three types of route segments 380: Normal route segments 380a represent specific channels for travel, typically a line segment or polygonal arc of sequential segments. Curved channels are represented as polygonal arc approximations, which can be automatically generated by the Facility Map Editor 218. Virtual route segments 380b are connections between route connectors 382 on different layouts, such as the vertical connectors in a building (e.g., stairways, elevators, and escalators), and cross-references to connectors on other maps (e.g., the front door of a building route network connecting to a campus map route). Open space route segments 380c are associated with a place, and indicate that a straight-line path can be created from any point in the place to any other point in the place. This would be used, for example, in a parking lot or building lobby, to indicate free travel throughout the place.

Route segments 380 and connectors 382 form a graph in which segments 380 are attached to connectors 382 but not directly to other segments. Attachments to normal route segments 380a need not be only at the endpoints; a connector can be attached anywhere along the length of the line segment or polygonal arc that constitutes the route segment 380. A connector 382 need not be located at the attachment point, for example a connector in an office doorway can be attached to the nearest point of a route segment in the adjacent hallway.

Places are “served” by route elements to establish the endpoints of a path. An open space segment serves the place it is associated with; a normal segment can serve any place it passes through or touches. If a place is not served by a segment, it is served by any connectors that touch it. Thus, an office would be served by the connector at its doorway; the corridor outside would be served by a route segment running the length of the corridor; and the connector would be attached at the nearest point of the segment. An asset or person can be linked to the route network through the place in which it is located.

All route elements can be associated with Credentials that are required for travel along or through the route element; and also with Transport Modes that are allowed or enabled to travel by this element. Corridor route segments, doors, and virtual segments for elevators might be accessible by foot and by wheel; whereas a virtual segment for a stairway would only be accessible by foot. A route element can specify specific Channels through it, and these may have differing credentials and/or transport modes. For example, a connector at a locked door might have one channel for travel in one direction, requiring a key, and another channel for travel in the other direction, not requiring any credentials. The transport mode can also be changed in a route element or channel, for example in a parking lot, the mode could change from foot to vehicle or from vehicle to foot. Travel time and distance, for route planning purposes, can be specified if they are not implied by the geometry associated with each route element.

A path is a specific sequence of travel steps, traversing a route network from one endpoint to another. A path is composed of path elements that include path segments and path connectors. Each path segment is associated with an underlying route segment, and each path connector is associated with an underlying route connector. The route planner can generate a single path from a source to a destination, or it can be used as an enumerator to list numerous paths in the order of increasing cost.

Facility Map Object Model 202 is advantageously a compact representation, particularly in FMML documents, achieved in part by “factoring” features to avoid repetitive data declarations over large numbers of map objects. Map objects are grouped into lists on layouts. For example, a layout can have zero or more lists of places, and each list defines zero or more place objects. Features of the list apply to all objects in the list. The lists of places, assets, persons, route elements, path elements, and artworks all have two features that reduce redundant data declaration. First, an “In” feature of a list is a reference to a layout or facility map in which all the map objects are assumed to be located. This acts an implicit “In Layout” reference on every polygon of every object in the list. Second, the object prototype feature of a list acts as an implicit prototype reference for every object in the list. Map objects that do not specify their own prototype will use the object prototype defined on their list instead.

Another factoring feature is Aliases. An alias is a name used to indicate a complete reference within a facility map. A facility map can declare a number of aliases; then, map objects in that facility map can use the aliases wherever a reference is required, instead of spelling out the complete details for each reference.

Each facility map 301 records information about its authoring and deployment, to inform other facility maps how to establish references into this map, and to inform the various tools in the Facility Map Framework 200 how to access the data for this map. Each map 301 records an Authoring Source, specified by a type and an identification string, indicating the primary source of authoring data. Normally, this will specify the FM-VISIO file from which this facility map was created; this will enable VISIO-based tools to access the FM-VISIO data directly. Each map 301 also records a master source that tells how and where the facility map data is available at run-time for applications to load. References created into this map will use the master source information to populate the map source specification in the reference. This information allows applications to select the proper map provider and to indicate to it the specific facility map desired.

The master source data also supports disconnected operation, i.e. applications on devices (usually mobile devices) that are only connected intermittently to the network. A map provider that reads a map can create a local cached copy on the mobile device. Later, when this local copy is opened, the map provider notes both the local name (filename on the device) and the permanent name (the master source data) for the map. Whenever another map has a cross-reference to the master source, the Facility Map API will notice this and use the locally cached copy of the map instead. In this way, all references into a map will automatically be made to a local copy of the map when one is available, so a mobile device can keep local copies of maps and they will automatically “federate” seamlessly with the same connections and cross-references as the original master maps.

Map Providers are the software components that read map data from a Source, and present that data in the form of a facility map to the Facility Map API. FMAPI has a compile-time plug-in model so that applications can incorporate providers that are not predefined in FMAPI 204.

Object Expiration is also supported by some providers. In object expiration, the expiration may be specified for individual layouts or other map objects. An application can check any layout or map object to see if it needs to be refreshed. If so, the provider is asked to give a new copy of just the layout or object in question. The provider wraps the new layout or object in a facility map, so it returns an actual map; but FMAPI ignores the map wrapper (and layout wrapper, if an individual map object is refreshed). The expired layout or map object is deleted from FMAPI, and the new layout or map object replaces it.

When expiration and refresh are combined with prototype maps, a mechanism is created for updating the locations of individual objects or entire populations of objects in real time. In the example of prototype maps, goods are moving through a facility—the locations would probably come from some sensor system as a sensor layer 388, and would be exposed through an FMOWS server presenting a prototype map for the objects with just the location data for each object. The entire set of object locations could be provided to an application through map expiration; or individual objects' locations through object expiration.

The Facility Map Framework 200 can generate Events in FM API 204, based on changing data about objects. FMF events are .Net “events” in C#, generated when a specified object enters, exits, or moves within a specified place. The application creates a Tracker that specifies the object and place and conditions for event generation; when the object moves in a way that satisfies the condition, an event is generated. The application can subscribe to these events in the normal way using .Net. Object motion is only checked through refresh operations as described above, so the application must drive the process of updating the objects' locations.

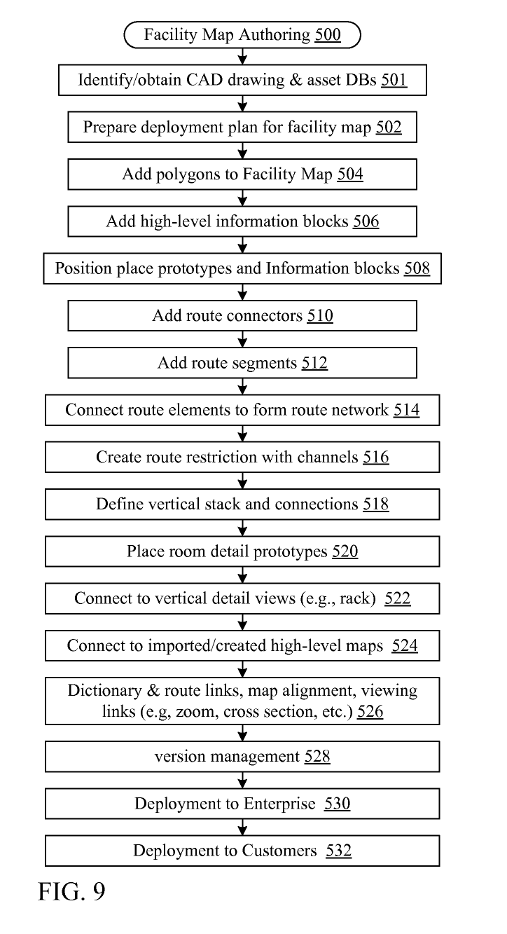

In FIG. 9, a methodology 500 for authoring a facility map is depicted. In block 501, CAD drawings and asset databases are identified and obtained. In block 502, a deployment plan is prepared for a facility map. Defining directories and filenames assists in assuring accurate cross references and how files will be presented to the users, as well as what services may be required to carry this out (File shares, FTP servers, Web services, etc.). Considerations for the deployment plan include identifying campus maps as well as building maps that should be included. Detail maps for rooms, etc., may be owned by the tenants, and therefore need to be in a place that the tenants can control. It is easy for tenants to link upward to the building and campus maps; but the real estate department may need to be involved if the campus and building maps will link to the tenants' detail maps. Deployment plans can include raw source data, FM-VISIO files created during the authoring process, and the final FMML files to be deployed.

In block 504, polygons are added to the facility map. Ideally, these polygons should cover the entire surface area of each building floor, and should not overlap. This process is sometimes called “polylining” in architectural practice. Polylining may be performed in modeling programs, in drawing programs (such as VISIO), or in computer-aided facilities management (CAFM) software. Examples of polygons are spaces for each office, lab, and meeting room, a lobby, lounge, printer alcove, and utility closet, vertical connector landings (e.g., stairs and elevators), and corridors. Corridors may be covered by several polygons as needed. Any spaces that are of individual interest should be given a name.

In block 506, high-level information blocks are added to the facility map. In order to define map objects we need to be sure they can have names and/or IDs. This can be accomplished by placing facility map and layout information blocks. For example, if an FM-VISIO file is to become a single facility map, it will contain a single facility map information block, such as in root layout (i.e., the “default” view to be used when an application simply says it wants to draw the map without indicating a specific layout.) A facility map information block should be placed on the map page for the root layout, i.e. the first floor (or ground floor). Next, each page that will be exported as a layout needs a layout information block. These information blocks define whether the map and/or layouts will contain name dictionaries, ID dictionaries, or both. Containing a dictionary means that objects can be looked up by applications using a name string and/or ID string. The easiest situation is to create both a name dictionary and an ID dictionary for the entire map, but not for the individual layouts. When authoring marks are dragged into the drawing, or created in other ways, they will automatically be assigned names and ID strings, if the facility map and/or layout settings call for such dictionaries.

In block 508, place prototypes and information blocks are added. To create place prototypes, draw one rectangle or similar shape for each type of space, and label it with the space type name. It is best to avoid conflicts with individual spaces, so for example if there will be a place called “Lobby”, then the corresponding prototype might be called “Lobby Space”. Drag in a Place Info Block, and group it with the rectangles for the place prototypes.

In block 510, route connectors are placed. In block 512, route segments are added. In block 514, route elements are connected to form route network. In block 516, route restrictions are created by using channels. In block 518, vertical stack and connections are defined. In block 520, room detail prototypes are placed. In block 522, room details are connected to vertical detail views (e.g., rack). In block 524, connections are made to imported/created high-level maps where cross referenced. In block 526, additional provisioning of the facility map is made, such as defining dictionary links, route links, map alignment, and viewing links (e.g., zoom, cross section, etc.). In block 528, version management is performed. In block 530, the authored facility map is deployed to the enterprise. In block 532, the facility map is deployed to customers.

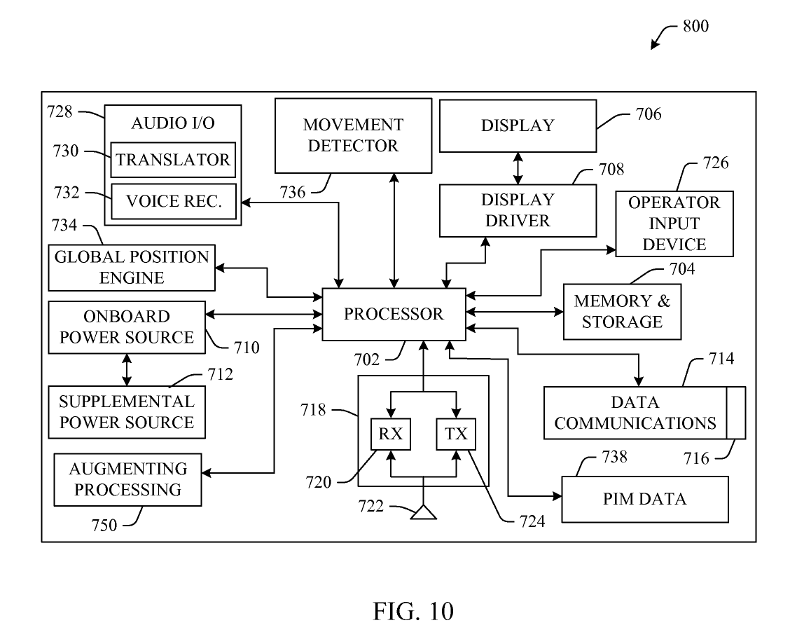

Referring now to FIG. 10, there is illustrated a schematic block diagram of a portable hand-held device 700, such as dashboard device, according to one aspect of the subject invention, in which a processor 702 is responsible for controlling the general operation of the device 700. The processor 702 can be programmed to control and operate the various components within the device 700 in order to carry out the various functions described herein. The processor 702 can be any of a plurality of suitable processors (e.g., a DSP-digital signal processor). The manner in which the processor 702 can be programmed to carry out the functions relating to the subject invention will be readily apparent to those having ordinary skill in the art based upon the description provided herein.

A memory and storage component 704 connected to the processor 702 serves to store program code executed by the processor 702, and also serves as a storage means for storing information such as current locations, infrared target locations, user states, location-based data, location-based services or the like. The memory and storage component 704 can be a non-volatile memory suitably adapted to store at least a complete set of the information that is acquired. Thus, the memory 704 can include a RAM or flash memory for high-speed access by the processor 702 and/or a mass storage memory, e.g., a micro drive capable of storing gigabytes of data that comprises text, images, audio, and video content. According to one aspect, the memory 704 has sufficient storage capacity to store multiple sets of information, and the processor 702 could include a program for alternating or cycling between various sets of display information.

A display 706 is coupled to the processor 702 via a display driver system 708. The display 706 can be a color liquid crystal display (LCD), plasma display, touch screen display, or the like. In one example, the display 706 is a touch screen display. The display 706 functions to present data, graphics, or other information content. Additionally, the display 706 can display a variety of functions that are user selectable and that control the execution of the device 700. For example, in a touch screen example, the display 706 can display touch selection icons that facilitate user interaction for control and/or configuration.

Power can be provided to the processor 702 and other components forming the hand-held device 700 by an onboard power system 710 (e.g., a battery pack or fuel cell). In the event that the power system 710 fails or becomes disconnected from the device 700, a supplemental power source 712 can be employed to provide power to the processor 702 (and other components (e.g., sensors, image capture device, . . . )) and to charge the onboard power system 710, if a chargeable technology. For example, the alternative power source 712 can facilitate an interface to an external grid connection via a power converter. The processor 702 of the device 700 can induce a sleep mode to reduce the current draw upon detection of an anticipated power failure.

The device 700 includes a communication subsystem 714 that includes a data communication port 716, which is employed to interface the processor 702 with a remote computer, server, service, or the like. The port 716 can include at least one of Universal Serial Bus (USB) and/or IEEE 1394 serial communications capabilities. Other technologies that can also be employed are, but are not limited to, for example, infrared communication utilizing an infrared data port, Bluetooth™, Wi-Fi, Wi-Max, etc.

The device 700 can also include a radio frequency (RF) transceiver section 718 in operative communication with the processor 702. The RF section 718 includes an RF receiver 720, which receives RF signals from a remote device via an antenna 722 and can demodulate the signal to obtain digital information modulated therein. The RF section 718 also includes an RF transmitter 724 for transmitting information (e.g., data, services) to a remote device, for example, in response to manual user input via a user input (e.g., a keypad, voice activation) 726, or automatically in response to the completion of a location determination or other predetermined and programmed criteria.

The transceiver section 718 facilitates communication with a transponder system, for example, either passive or active, that is in use with location-based data and/or service provider components. The processor 702 signals (or pulses) the remote transponder system via the transceiver 718, and detects the return signal in order to read the contents of the detected information. In one implementation, the RF section 718 further facilitates telephone communications using the device 700. In furtherance thereof, an audio I/O subsystem 728 is provided and controlled by the processor 702 to process voice input from a microphone (or similar audio input device). The audio I/O subsystem 728 and audio output signals (from a speaker or similar audio output device). A translator 730 can further be provided to enable multi-lingual functionality of the device 700.

In another implementation, the device 700 can provide speech recognition 732 capabilities such that when the device 700 is used as a voice activated device, the processor 702 can facilitate high-speed conversion of the voice signals into text or operative commands. For example, the converted voice signals can be used to control the device 700 in lieu of using manual entry via the keypad.

Other devices such as a location detection engine 734 and/or a movement detector 736 can be provided within the housing of the device 700 to affect functionality described supra. For example, the location detection engine 734 can be provided to affect the analyzer component (e.g., processor 702) to identify and/or provide location-based data and/or services. In another example, the movement detector 736 can augment the information provided by the location detection engine 724 which further facilitates the analyzer component (e.g., processor 702) to infer or predict a target location of the device 700.

The device 700 can contain an augmenting processing 750 that enhances various features as part of a facility map framework 200. Examples of an augmenting processing include an artificial intelligence (AI) component that facilitates automating one or more features in accordance with the subject invention. The subject invention (e.g., with respect to determining a present or target location, communicating location-based data and/or services . . . ) can employ various AI-based schemes for carrying out various aspects thereof. For example, a process for determining or inferring a target location or for determining a location-based service (or data) can be facilitated via an automatic classifier system and process.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Other classification approaches, including Näive Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the subject invention can employ classifiers that are pre-trained (e.g., via a generic training data from multiple users) as well as methods of reinforcement learning (e.g., via observing user behavior, observing trends, receiving extrinsic information). Thus, the subject invention can be used to automatically learn and perform a number of functions, including but not limited to determining, according to a predetermined criteria, a present and/or target location, location-based data and/or services, when/if to communicate data location-based services, which language and/or translation to employ, etc.

Another example of augmenting processing 750 includes a rules-based logic component. In accordance with this alternate aspect, an implementation scheme (e.g., rule) can be applied to define thresholds, initiate location detection, facilitate communication of location-based services, etc. By way of example, it will be appreciated that the rule-based implementation can automatically define criteria thresholds whereby an analyzer component or processor can employ the thresholds to determine a location-based service and/or set of data.

In response thereto, the rule-based implementation can affect determination of location-based data and/or services by employing a predefined and/or programmed rule(s) based upon any desired criteria (e.g., distance). It is to be appreciated that any of the specifications and/or functionality utilized in accordance with the subject invention can be programmed into a rule-based implementation scheme. It is also to be appreciated that this rules-based logic can be employed in addition to, or in place of, AI reasoning components

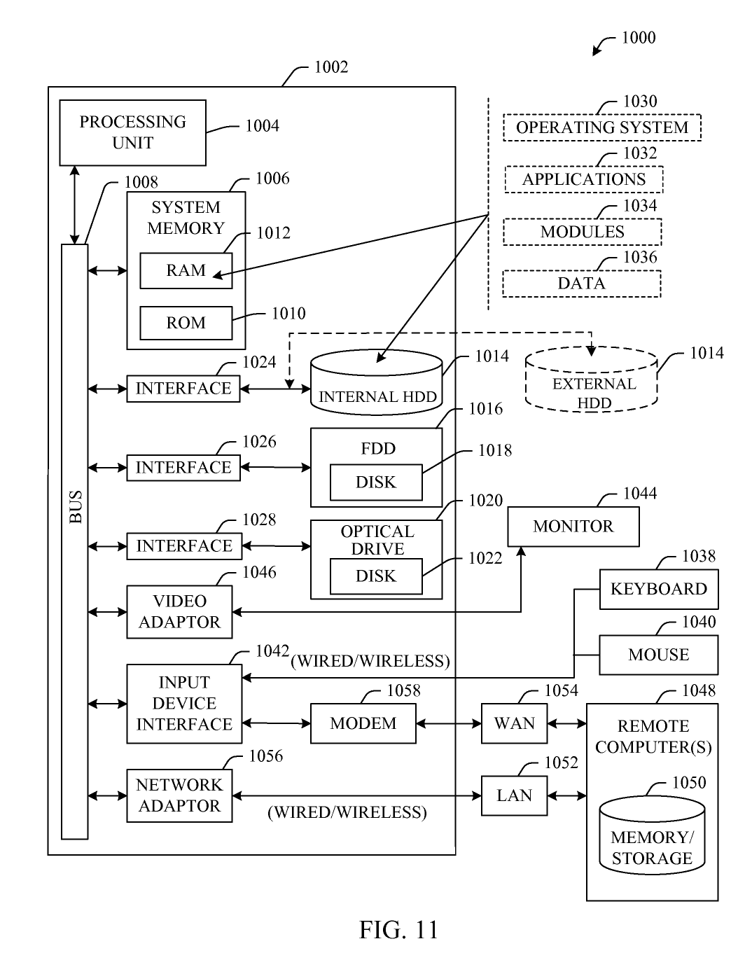

The aforementioned functionality can be employed within any computing device including, but not limited to, a cellular telephone, smartphone, pocket computer, laptop computer, PDA or the like. Referring now to FIG. 11, there is illustrated a block diagram of a computer operable to execute the disclosed architecture, such as to execute the FM API 204 or other components that create, maintain or execute applications upon the facility map object model 202. In order to provide additional context for various aspects of the subject invention, FIG. 11 and the following discussion are intended to provide a brief, general description of a suitable computing environment 1000 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1000 for implementing various aspects of the invention includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cellular telephone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

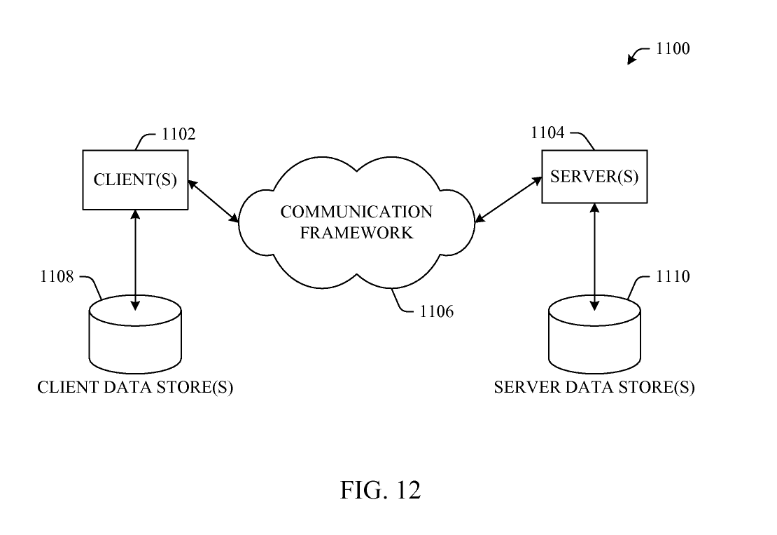

Referring now to FIG. 12, there is illustrated a schematic block diagram of an exemplary computing environment 1100 in accordance with the subject invention. As illustrated in FIG. 12, it is to be understood that the “client(s)” can be representative of a portable device and the “server(s)” can be representative of a host computer or other disparate portable device. As shown, the system 1100 includes one or more client(s) 1102. The client(s) 1102 can be hardware and/or software (e.g., threads, processes, computing devices). The client(s) 1102 can house cookie(s) and/or associated contextual information by employing the invention, for example.

The system 1100 also includes one or more server(s) 1104. The server(s) 1104 can also be hardware and/or software (e.g., threads, processes, computing devices). The servers 1104 can house threads to perform transformations by employing the invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various versions. It is, of course, not possible to describe every conceivable combination of components or methodologies for purposes of describing the various versions, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

Furthermore, although elements of the described aspects and/or versions may be described or claimed in the singular, the plural is contemplated unless limitation to the singular is explicitly stated. Additionally, all or a portion of any aspect and/or version may be utilized with all or a portion of any other aspect and/or version, unless stated otherwise.

What is claimed is:

1. A facility map system that facilitates providing location-based information, comprising:
a facility map model linking a plurality of disparate map sources by a plurality of route elements and cross references;
a sensing component responsive to an object moving within a geographic scope of the facility map model; and
a location service component that suggests a route through the route elements across the disparate map sources in response to the sensed location of the object.

2. The facility map system of claim 1, wherein the facility map model further comprises an asset component locating a plurality of assets within the facilty map model.

3. The facility map system of claim 1, further comprising a portable device comprising an output device depicting the route suggestion to a user, wherein the facility map model further comprises criteria associated with at least one route element, the location service component responsive to a mobility limitation and responsive to the sensed location of the object.

4. The facility map system of claim 3, further comprising a hazard sensor responsive to hazardous condition sensed at a route element, the location service component responsive to suggest a route avoiding the route element having the hazardous condition.

5. The facility map system of claim 1, wherein the facility map model comprises a plan map of a building linked to a cross section depiction of an objects located within the plan map.

6. The facility map system of claim 5, wherein the cross section depiction comprises a depiction in elevation of a containment structure.

7. The facility map system of claim 6, further comprising a rendering components that displays a position of a target object on the containment structure to guide a user.

8. The facility map system of claim 1, wherein the sensing component further comprises a radio frequency identifier system.

9. The facility map system of claim 1, wherein the sensing component further comprises a global positioning system.

10. The facility map system of claim 1, wherein the facility map model further comprises security criteria associated with a route element, the location service component responsive to the security criteria to suggest an alternative route avoiding the route element having the security criteria.

11. A computer-readable medium having stored thereon computer-executable instructions for carrying out the facility map system of claim 1.

12. A computer-implemented method of communicating location-based information, comprising:
linking a plurality of disparate map sources with route connectors and route segments;
locating a plurality of assets with the plurality of linked map sources; and
routing a user from a present position to a selected place via the route connectors and route elements.

13. The computer-implemented method of claim 12, further comprising sensing current locations for objects within the geographic space represented by the linked plurality of disparate map sources and rendering this location of objects.

14. The computer-implemented method of claim 12, further comprising sensing a changed criteria of a route segment within a suggested route and suggesting an alternative route avoiding the route segment with the changed criteria.

15. The computer-implemented method of claim 12, further comprising depicting security restrictions along the suggested route to a user.

16. The computer-implemented method of claim 12, further comprising linking a cross sectional view of an object within a facility map to the facility map; and rendering the cross section view to the user to facilitate locating a target within the cross section view.

17. The computer-implemented method of claim 12, further comprising sensing a user by global positioning system.

18. The computer-implemented method of claim 12, further comprising sensing a user by radio frequency identification.

19. The computer-implemented method of claim 12, further comprising sensing a user by wireless node access within a facility.

20. A wayfinding device that facilitates generation of a location-based service, comprising:
means for defining routes and mobility constraints through a geographic road map, a facility map, to a detail map within the facility map;
means for determining a current location of the wayfinding device;
means for determining a target location within a facility map object model;
means for sensing a changed state affecting a route from the current location to the target location; and
means for communicating a route to the wayfinding device avoiding the changed state affecting the route.
